(19) United States
(12) Patent Application Publication
(10) Pub. No.: US 2009/0063216 A1
(43) Pub. Date: Mar. 5, 2009

(54) On-Line Dynamic Certification

(75) Inventors: Fred Kerimov, Fairlawn, NJ (US); Shelley M. Kluger, Briarcliff Manor, NY (US); Alexi Tsonopoulos, New York, NY (US); Alon Paul Herman, Port Chester, NY (US); Aleksandr Dreysler, Brooklyn, NY (US); Andrei Tokar, Fairlawn, NJ (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/848,237

(22) Filed: Aug. 30, 2007

(51) Int. Cl. G06Q 10/00; G06Q 40/00

(52) U.S. Cl. 705/7; 705/35

(57) ABSTRACT

A method for ensuring compliance with an investment policy is described. Information regarding past or contemplated future trades is collected. Financial and/or fiduciary positions are then automatically approved, automatically denied, or submitted for approval or denial by a supervisory user.

### BACKGROUND

Employees in the various industries, such as the investment banking industry, may become privy to non-public information during the ordinary course of business. Consequently, companies are concerned with the financial investments of their employees. Employees who trade on non-public information may violate insider-trading laws. Further, employees who have a personal financial stake in industries they deal with on behalf of the company may have a real or perceived conflict of interest.

Because companies wish to avoid even the appearance of impropriety, many regulate the investments made by their employees. Often, employees must assent to the policy of the company on securities ownership and other financial or fiduciary undertakings as a condition of employment. Employees also re-certify assent to and compliance with the policies on a periodic basis.

The policies to which employees must agree may include monitoring. For example, the employee or their affiliates (where the employee has a beneficial interest) may need to make investments in a brokerage account monitored by the employer. Investments in non-monitored accounts would need to be disclosed and possibly transferred to a monitored account.

In addition to monitoring past financial activity, companies may require their employees to seek clearance before purchasing or selling securities. For each employee, there may be a list of securities in which trading is never permitted. Investment in securities not on this list may still be ill advised and therefore require approval.

Assuring assent to the investment policy, disclosure of employees' investments, and pre-clearance for contemplated trades is a complicated and time-consuming process. When each of these functions is managed by a different person or division, employees may have to complete duplicative paperwork and the company may have to enter the same information into more than one database. Moreover, the volume of employees and trades to be monitored leads to a high probability of error. There is a need in the art to automate the investment monitoring and compliance tasks as well as to integrate them to avoid duplicative processing and data entry.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to at least one aspect of the present invention, one or more computer readable media store computer executable instructions that, when executed, perform a method for ensuring compliance with an investment policy. Information about brokerage accounts and outside investments is collected from users. The brokerage accounts directly provide trade data. Requests for pre-clearance of a contemplated securities transaction are collected from users, and each request may be automatically approved, automatically denied, or held pending approval from another user. Reports of suspicious or otherwise note-worthy trades are generated.

This Summary introduces a selection of concepts in a simplified form. The concepts are further described below in the Detailed Description. The Summary is not intended to identify key features or essential features of the claimed subject matter, nor is it intended to limit the scope of the claimed subject matter.

### BRIEF DESCRIPTION OF THE DRAWINGS

A more complete understanding of aspects of the present invention and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present invention may be implemented;

FIG. 2 is an example block diagram that illustrates the flow of information between components in accordance with at least one aspect of the present invention;

FIG. 3 is an illustrative user interface for interaction with an embodiment of the present invention;

FIGS. 4A-4C are illustrative user interfaces for inputting and updating financial or fiduciary information in accordance with at least one aspect of the present invention;

FIG. 5 is an illustrative user interface for inputting information about specific securities transactions in accordance with at least one aspect of the present invention;

FIG. 6 is an illustrative user interface for displaying the status of an employee's accounts to a supervisor and allowing the supervisor to input an approval or denial in accordance with at least one aspect of the present invention;

FIG. 7 illustrates a compliance form where the form is a questionnaire in accordance with at least one aspect of the present invention;

FIG. 8 illustrates a user interface for tracking employees' progress in completing compliance forms in accordance with at least one aspect of the present invention;

FIG. 9 illustrates a search interface in accordance with at least one aspect of the present invention;

FIG. 10 illustrates an interface for creating and sending emails or other notifications to users or groups of users and tracking progress in accordance with at least one aspect of the present invention;

FIG. 11 illustrates an interface for requesting pre-clearance for a securities transaction in accordance with at least one aspect of the present invention;

FIG. 12 illustrates an interface for viewing submitted pre-clearance requests in accordance with at least one aspect of the present invention;

FIG. 13 illustrates an interface for approving or denying a pre-clearance request in accordance with at least one aspect of the present invention; and

FIG. 14 illustrates an interface for creating exceptions by individual group to default policies in accordance with at least one aspect of the present invention.

### TERMINOLOGY

Throughout this specification, “the system” refers to something containing or forming a part of an embodiment of the present invention. References to “the system” are not intended to be limitations; they do not imply that there is only one system, only one computer, etc. The words “the system” are used with reference to multiple aspects that are disclosed. However, not all aspects are necessary to the invention. Thus, “the system” discussed with reference to one aspect or embodiment of the invention is not necessarily the same system that is referenced when discussing another aspect or embodiment of the invention.

This specification makes extensive use of the words “employee,” “user,” and “supervisory user.” The term “employee” is meant to encompass anyone the operator of the system has an interest in monitoring with the system. It is not meant to embrace any formal or legalistic distinctions between the various types of people or entities that perform work for a company.

The term “user” is meant to encompass anyone who has an account on the system or about whom information is entered into the system. “Supervisory users” is a subset of users and includes those who have authority within the system to approve or deny requests or to otherwise view and/or modify information inputted by or about other users.

### DETAILED DESCRIPTION

In the following description of the various embodiments, reference is made to the accompanying drawings. The drawings are a part of the description and illustrate various embodiments of the invention. It is to be understood that other embodiments may be utilized and structural and functional modifications may be made.

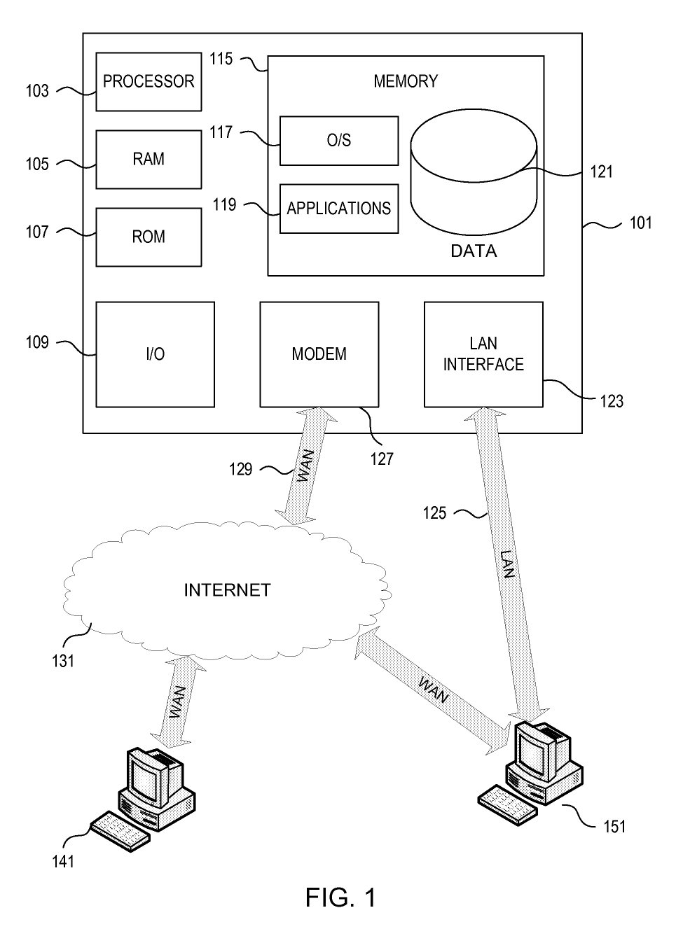

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media can be any available media that can be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that computer 101 can access.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared, and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP, HTTPS, and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like. As described herein, input/output module 109 may also include a reader/scanner to read/scan deposit items, including monetary items, to identify the type of monetary item it is. Such readers/scanner may read magnetic ink character recognition (MICR) data and/or other data from the monetary items for identification of the type of monetary item.

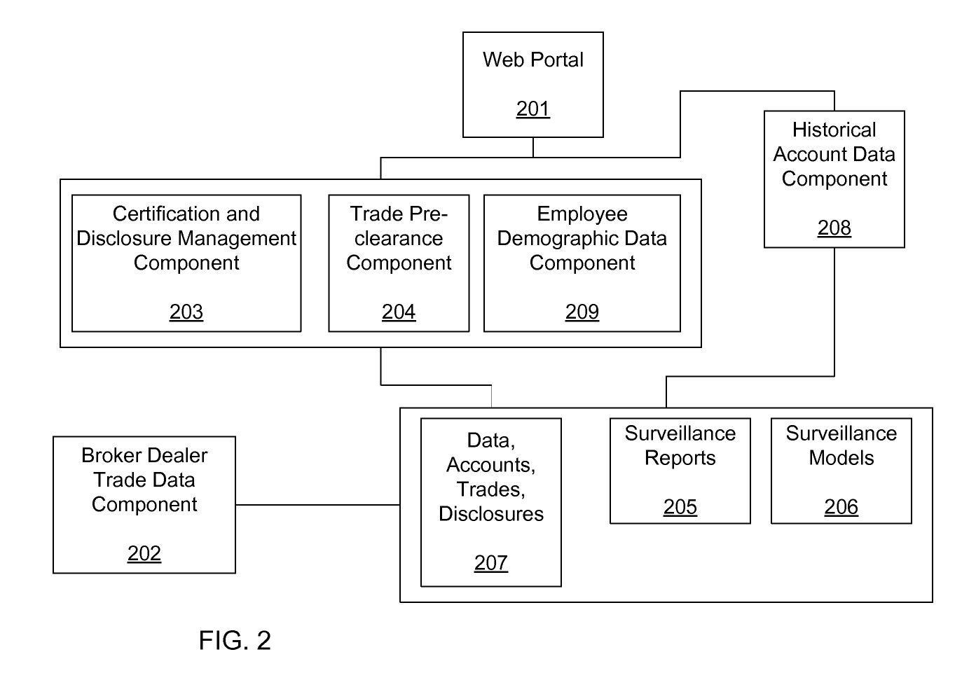

FIG. 2 illustrates an example flow of information in accordance with at least one aspect of the present invention. Web portal 201 may receive information from a user and, responsive the received input, display information to the user. The user interaction occurs with respect to multiple functions related to compliance with company and/or federal policy. For instance, web portal 201 may be used to allow a user to agree to certain conditions, to certify the truth or falsehood of various statements, and to disclose other information. The function of managing certifications and disclosures 203 may aggregate this information for one or more users and report that information back to a supervisory user who reviews or approves the responses via web portal 201. Such a web portal 201 may be a private web portal accessible via an entity-standardized sign on system and following data security rules for access to the entity's systems.

The users' information also may be sent to database 207, which stores the disclosures made by the employee as well as other information. Database 207 may also create an audit trail of information collected from or about each user, optionally including supervisory actions such as approvals of accounts or trades. Database 207 may or may not be synonymous with database 121. Database 207, like the rest of the system, may be distributed over one or more computers and/or storage devices.

An example of the other information stored in database 207 may be information 202 from designated broker dealers. Users who have accounts with designated broker dealers may have statements of their account, or other account information, transmitted automatically to the system and optionally recorded in database 207. This saves the user the hassle of entering trade data for these accounts, and it provides the system with a simplified and more reliable method of collecting information.

Users may also use web portal 201 to request pre-clearance for a trade 204. Supervisory users may approve or deny these requests through web portal 201. The request, as well as the approval or denial, may be logged in database 207. Pre-clearance requests may be denied or approved automatically in some cases. In other cases, the requests may be held pending review by a supervisory user. An employee demographic data component 209 may include data from another system or may maintain the data. Employee demographic data may be used by one or more other components, such as the pre-clearance trade component 204, to obtain employee data as needed. Such data may include a name of the employee, a location of the employee, such as by city or state, a building that the employee works out of, a title of the employee, a unique code associated with the employee, a line of business or division, or some other identification data.

By using information from the designated broker dealers 202, database 207 may be used to compare the trades for which pre-clearance was requested 204 with the trades that actually occurred. In addition, large accumulations in one company, short-term trading, or other activity of interest to supervisory users may be detected by generating reports 205 from the information in database 207. These reports may be displayed via web portal 201. A historical account data component 208 may be included between the web portal 201 and database. The historical account data component 208 may include historical employee account data in addition to historical employee affiliate account data. Previously entered or converted data for employee or employee affiliate accounts that were previously disclosed to the system may be maintained here. When generating various reports and/or alerts, such data may be utilized. In addition, such data may be utilized by other components of the system as needed.

In addition to generating reports upon request, database 207 may be used automatically to generate warnings regarding certain activity. For instance, a surveillance model 206 may detect short-term trading in investment products generally considered to be long-term instruments. If such activity occurs, the surveillance model 206 may alert the appropriate users via web portal 201 or via other means, such as email.

While FIG. 2 discloses a web portal 201 as the method of exchanging information with the other components of the system, other methods of information entry and exchange also could be used. For example, users could run a software program other than a web browser to connect to the computer(s) running components such as the trade pre-clearance component 204. Similarly, it may be advantageous in some applications to allow user input only from the same computer(s) as the one(s) running the system.

Components 203, 204, 205, 206, 207, 208, and 209 are illustrative, and need not all be present. In some embodiments, one or more of the components 203-209 may be maintained within the same database. Each component, as well as the combination of all components, may be comprised of instructions running on more than one computer. Finally, the flow of information in FIG. 2, like in all of the figures disclosed, is not limiting. In FIG. 2, no data flow is indicated between the trade pre-clearance component 204 and the certification and disclosure management component 203. However, in some embodiments of the invention component 204 collects information directly from component 203. This could happen, for example, when the collected information is useful for determining whether to automatically approve or deny a trade. In some embodiments, the same information may be retrieved from database 207.

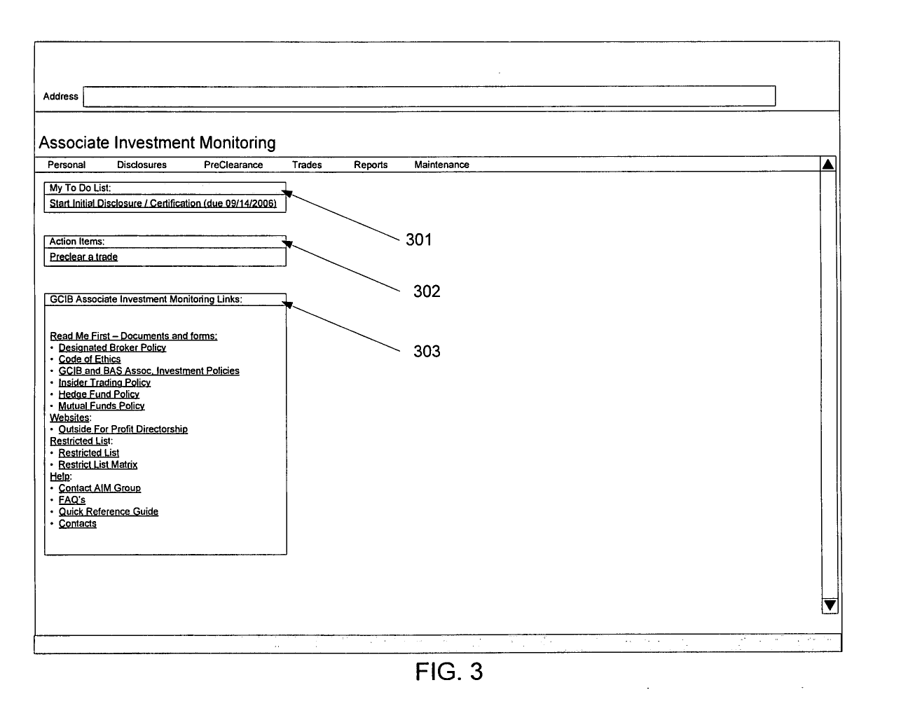

FIGS. 3-14 disclose various embodiments of the present invention as viewed through a web portal, such as web portal 201. As should be understood by those skilled in the art, the various user interfaces and displayed data is dynamic with respect to the individual accessing the information. If the employee accessing the information is part of one business unit, the home page accessed may be different from a different employee accessing a home page of system when the employee is part of a different business unit. FIG. 3 is an example of an illustrative home page. With respect to FIG. 3, To Do list 301 includes links for items the user may be required to complete in order to be designated as compliant with the policies of the company. For example, users may have to periodically certify assent to the corporate disclosure policy or confirm that they have no conflicts of interest. The To Do list 301 may include links to forms the user must complete. If the form is not completed by a designated due date, other capabilities of the system may be disabled, and management may be notified via a web portal, email, or other means.

Action Items list 302 includes links to forms the user may be requested to complete, but does not necessarily have to complete. For example, users may be required to pre-clear any securities transactions, but they do not need to trade securities. Hence, the Action Items list 302 includes a link to submit information about a contemplated trade for approval. If a user has already disclosed information, she may update that disclosure by clicking a link that would appear in Action Items list 302. If an update or recertification is mandatory because a pre-defined period of time has passed, then the corresponding link may appear in list 301. In certain embodiments, certain users may have rules based on their demographic data, for example, Bands 0-1, executive level employees, may see a different pre-clearance screen and rules based on their status. This flexibility in defining rules and screen views may be built into the system.

In accordance with at least one aspect of the present invention, the due dates for periodic disclosures or certifications by each employee may be staggered. This would allow those who review the disclosures to receive a steady stream of responses rather than multiple responses on the same due date.

Other areas of the web portal, such as links section 303, may include news, updates as to the status of a user's pending requests, or other information. For example, in FIG. 3 section 303 includes a list of links to the corporate policies of the company.

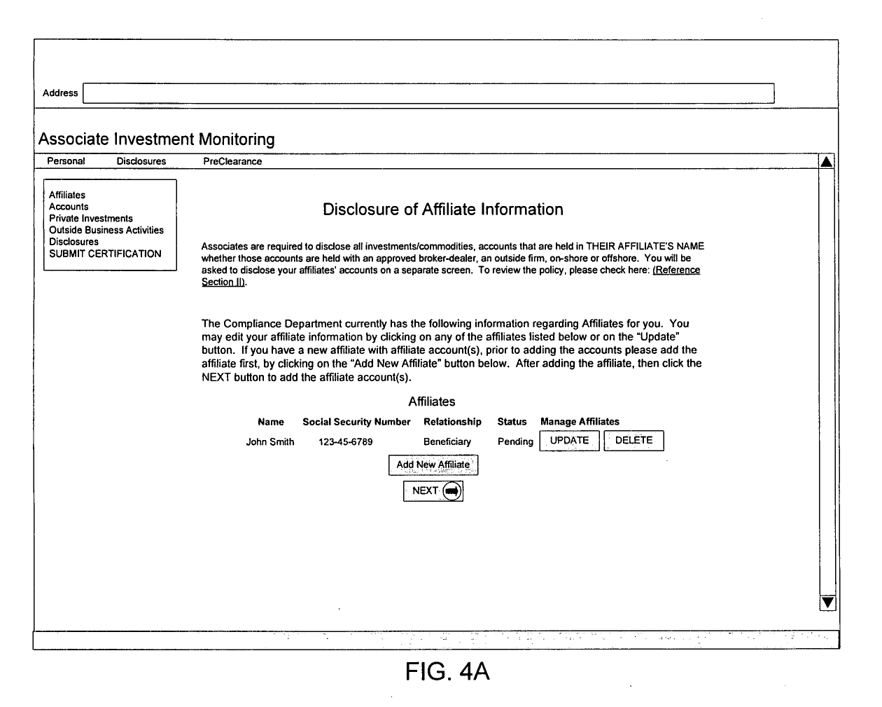

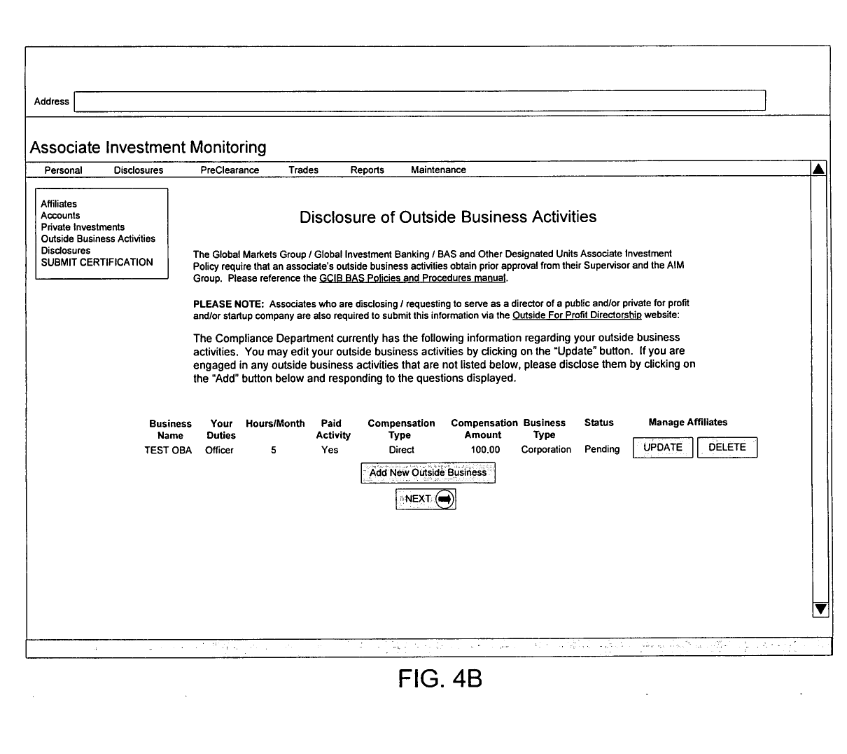

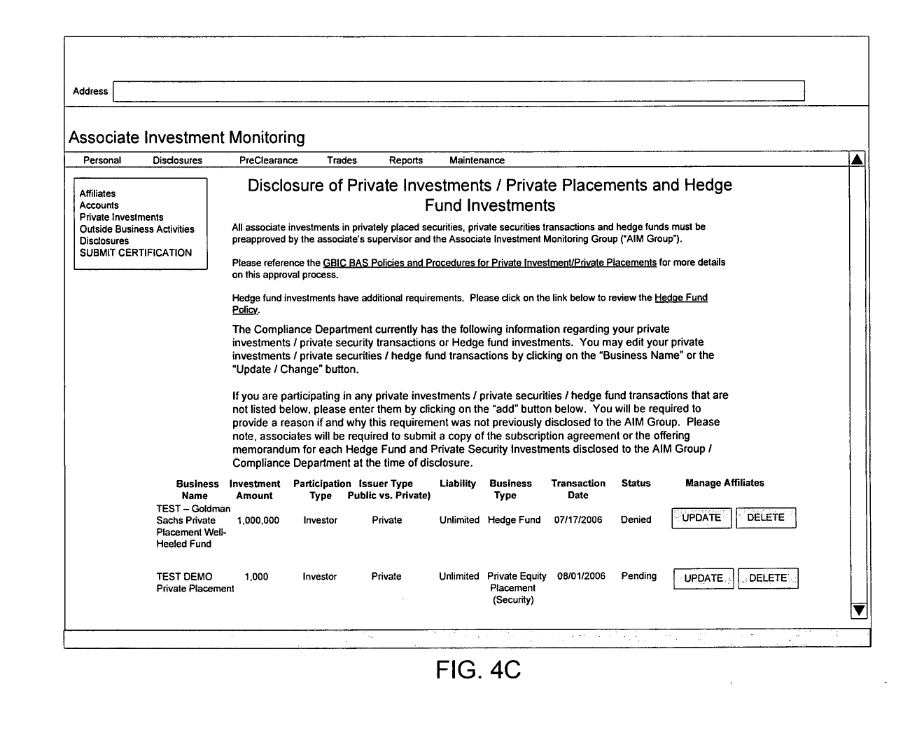

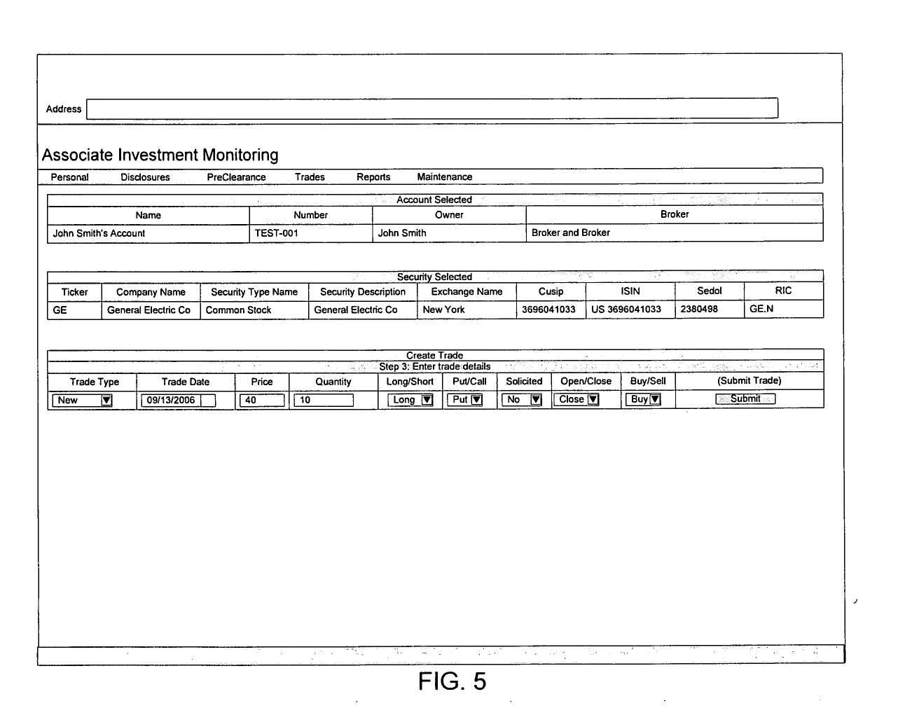

FIG. 4A illustrates an illustrative form into which a user may disclose accounts that hold securities subject to policies of a company. These accounts are not limited to the accounts owned by the user. They may also include accounts owned by others, such as a spouse. Because conflicts of interest or the appearance of impropriety may arise out of situations other than the ownership of publicly traded securities, disclosure of these other situations also may be reported through web portal 201. FIG. 4B provides an illustrative example. In FIG. 4B, a user reports outside business activities. Here, the user is an officer of a corporation. In FIG. 4C, a user reports private investments, private placements, and investments in hedge funds. Optionally, specific trades may be entered into the system as well, as illustrated in FIG. 5.

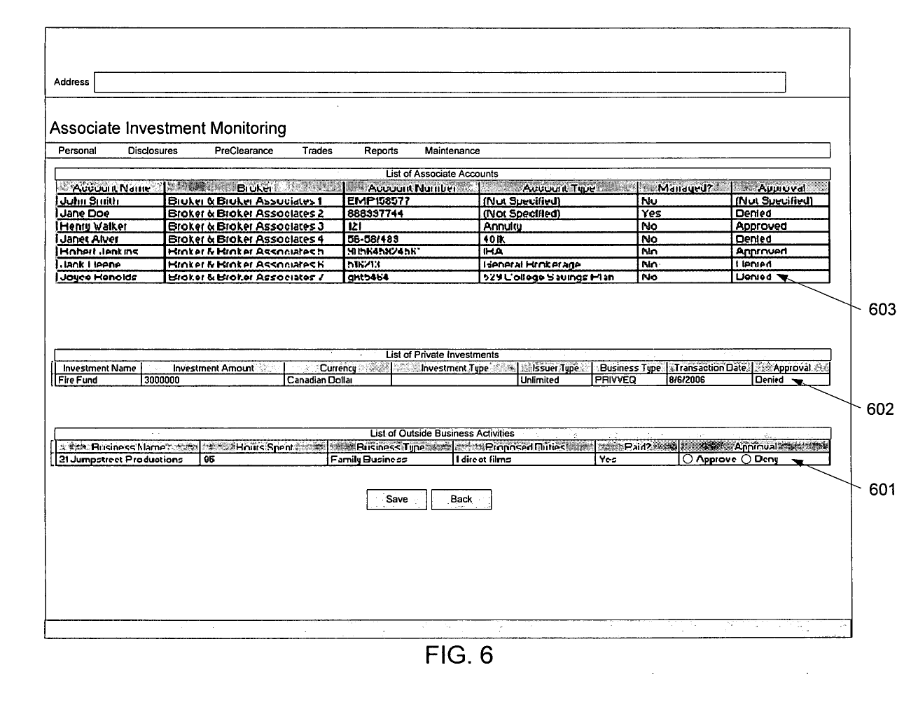

If any of the financial positions or trades made by an employee is contrary to a company policy, they may be denied by a supervisory user. In this context, examples of a supervisory user may include the employee's actual supervisor or a user who works in the company's compliance department. FIG. 6 illustrates a web interface, which shows the disclosed accounts of an employee. Cells 602 and 603, for example, identify whether an account or investment has been approved. Cell 601 shows an investment for which approval is pending. Ideally, investments are approved or denied before they occur. However, in cases where an investment is denied but the employee has already executed a trade, the executed trade may have to be reversed according the company policy. For example, a purchaser of a non-approved stock may have to sell the stock and donate any profit to charity. In some instances, such as trading in the stock of the employee's own company or trading in a stock for which the employee publishes reports or gives investment advice, approval may be denied automatically. Similarly, some transactions may be approved automatically, e.g., without the supervisory input shown in cell 601.

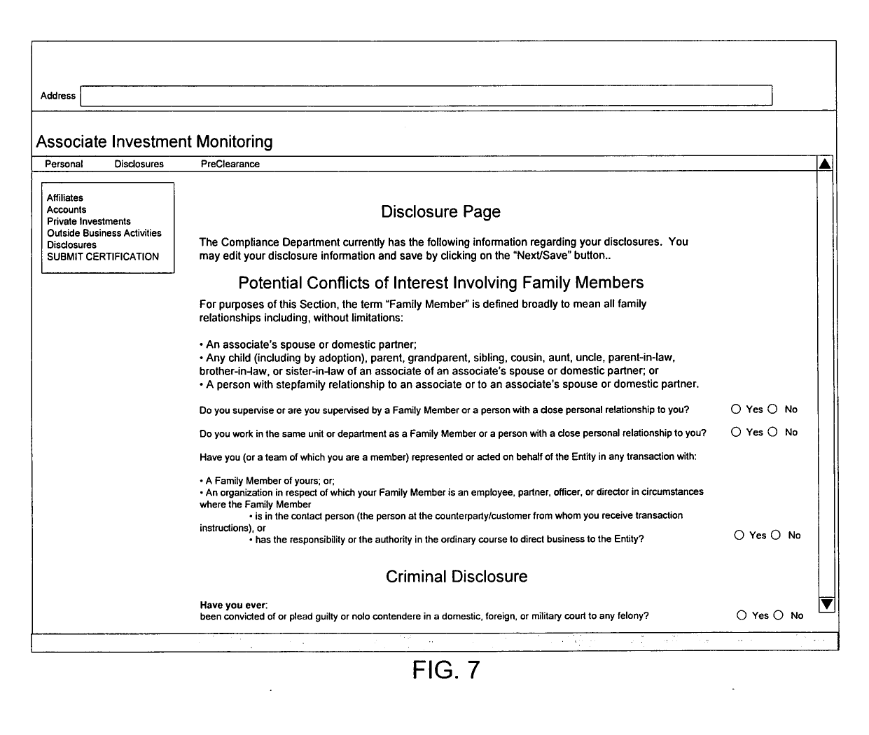

FIG. 7 illustrates a compliance form the user may be required to fill out in accordance with at least one aspect of the present invention. In this example, the form is a questionnaire to be completed by the user. In other cases, the form may be a statement of the company policy, or a revision of that policy, to which the user simply assents or dissents. Of course, dissenting may or may not be an option, depending on the situation.

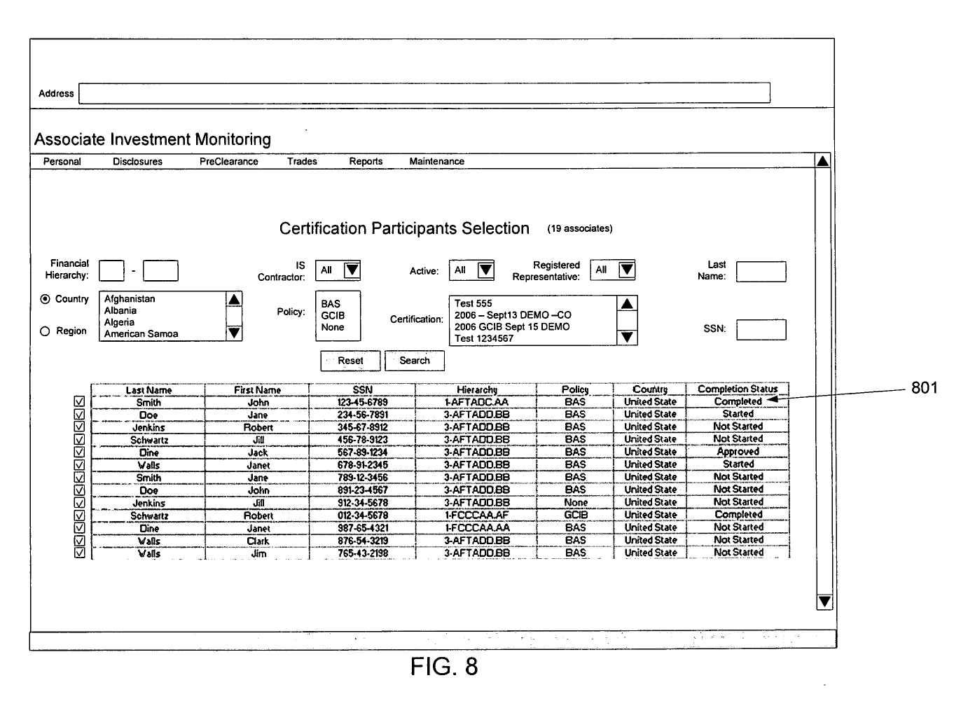

FIG. 8 shows one possible way for a supervisor to view employees' progress in completing a required form(s) in accordance with at least one aspect of the present invention. Column 801 indicates each user's progress in answering questions, assenting to policies, and/or disclosing information by displaying, for example, “Not Started,” “Started,” or “Completed.” Other status indicators, such as “Approved,” “Denied,” or “68% Complete” may also be displayed, as appropriate. The display of FIG. 8 allows supervisory users to see employee's progress in viewing or entering financial disclosures, questionnaires, or any other form available on the system. Forms may be pre-set in the computer instructions used to make the system. Alternatively, some or all forms may be created by the users of the system, either via a web interface or via an alternative means of inputting information to the system, such as a computer file. In addition to the content of the form itself, the user may optionally control which users must fill out or read the form, the date(s) on which the form is made available to each user, if users must periodically re-certify their answers and if so at what interval, and the due date for each user or group of users. In a preferred embodiment, the user will specify a time period between re-certifications or due dates and the system will automatically assign individual due dates to each user according to a predefined distribution. This provides the advantage of allowing a steady stream of responses to arrive instead of all responses arriving near the time of a single, system-wide or group-wide due date. One skilled in the art will recognize that these examples are illustrative, and that the user may control other aspects of user-created forms.

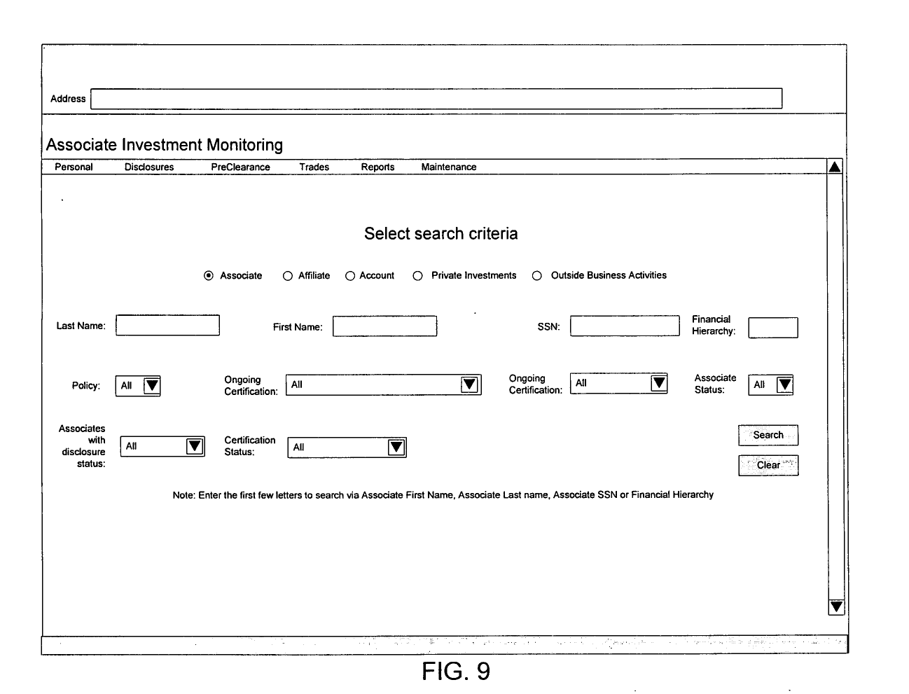

FIG. 9 shows an example of an interface through which a user can view information stored in the system in accordance with at least one aspect of the present invention. Such may be useful to an employee seeking to ensure that all relevant information has been entered. It also may be useful in making sure the system has received information that is delivered automatically, such as the electronic account statements transmitted from a designated broker dealer 202, as described above.

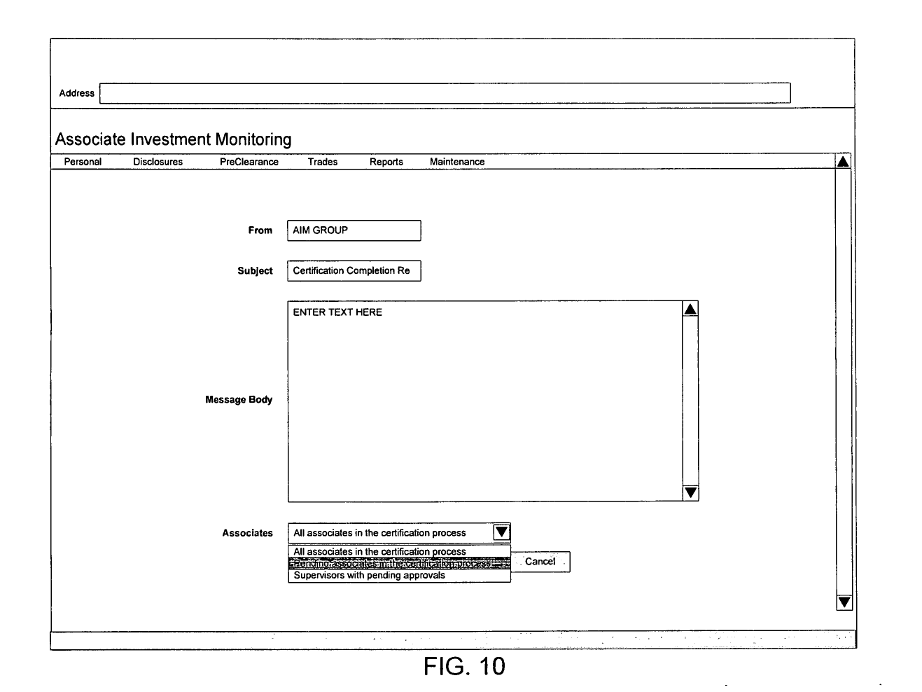

Searching and sorting capabilities are also useful for supervisors seeking to monitor the financial positions or progress of their supervisees. For instance, if a supervisor seeks to ensure that all of her supervisees assented to a confidentiality agreement (or other agreement) before beginning a project, the supervisor may view each employee's status using the screen disclosed in FIG. 9. E-mail reminders may be sent to all members of a group, or only to those members who have not yet assented, as shown in FIG. 10. In other contexts, the e-mail reminders screen may be used to send messages to other groups, such as a message to the supervisors whose employees have not yet completed a required task in the system. Among other options, messaging within the system may be used instead of or in addition to email.

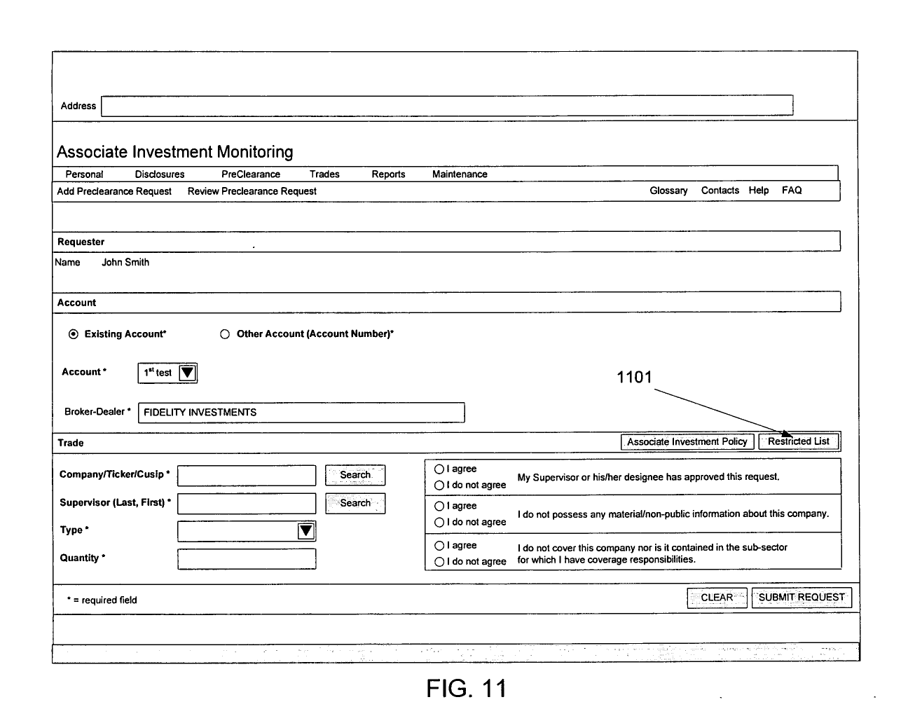

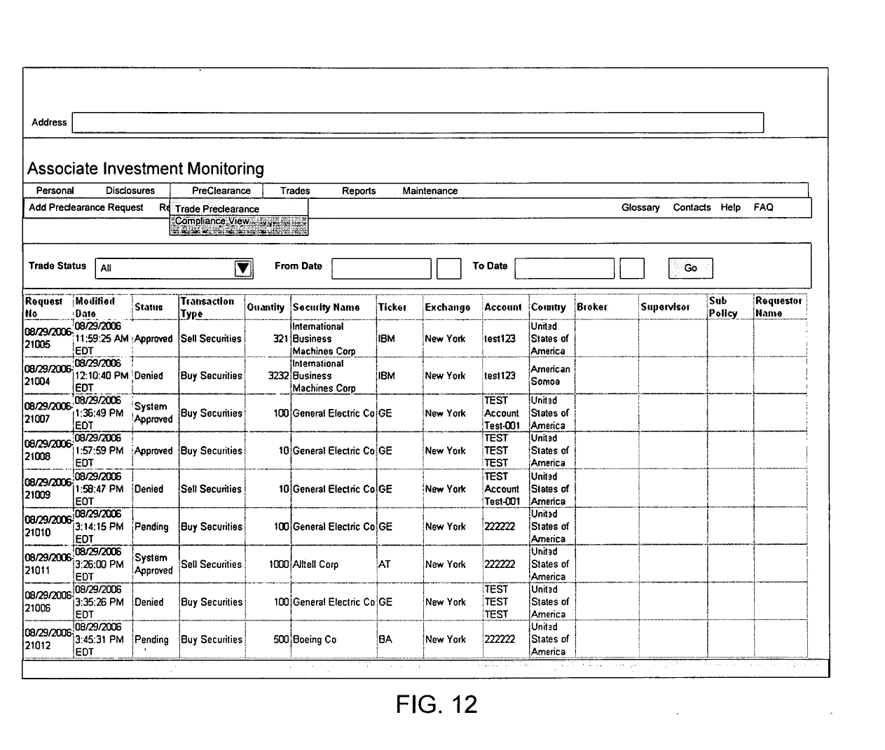

FIG. 11 illustrates a form in which a user can enter information about a contemplated transaction and request pre-clearance in accordance with at least one aspect of the present invention. The advantages of submitting a pre-clearance request electronically are numerous. For example, those in charge of approving the clearances can view requests from multiple employees in one place (as shown in FIG. 12) and receive alerts of new requests via email or other means. The list of requests may be sorted, searched, and color-coded. An audit trail may be created automatically, and in some cases, approval or denial can be fully automated. Button 1101 is a link to a “restricted list,” which is a list of securities in which trading is prohibited for this user. Pre-clearance requests to trade in a restricted security may be denied without wasting the time of a supervisory user. Similarly, some pre-clearance requests may be approved automatically.

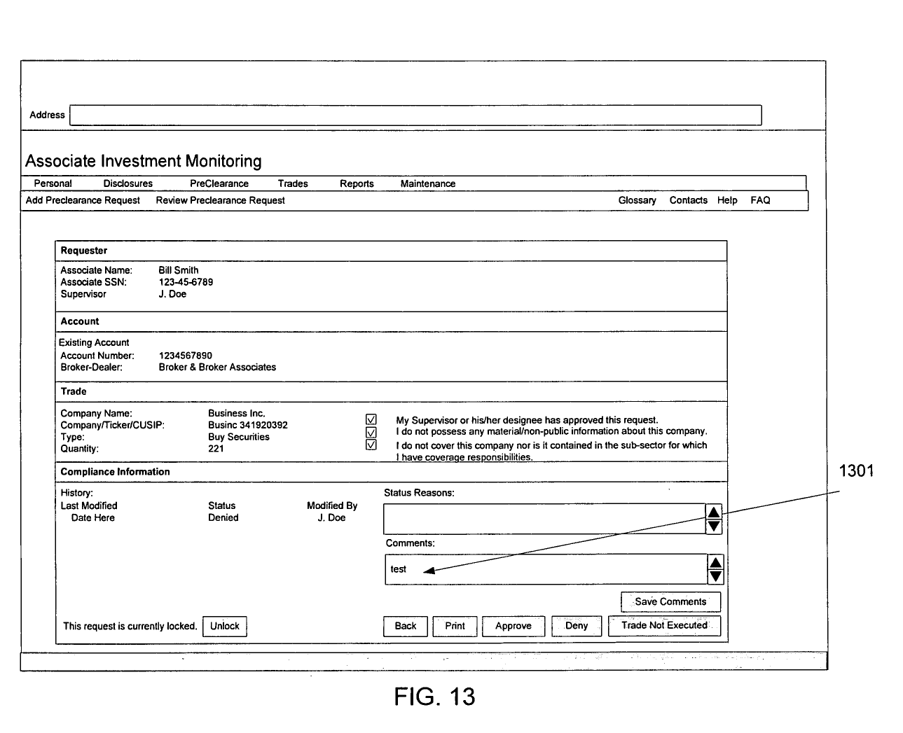

In addition to the time savings for the supervisory user, immediate feedback is also advantageous to the requesting user. Whether approved or denied, users also may learn the reason for the decision made through the online system quickly. If the system acted on the request automatically, then it could also indicate the reason for the decision. If a supervisory user approved or denied the request, that user could leave a comment along with the decision. FIG. 13 illustrates a form that a supervisory user may use to approve or deny a request in accordance with at least one aspect of the present invention. Text box 1301 allows inclusion of comments.

This ability for rapid feedback provides users the chance to modify requests in order to increase the likelihood of approval. For instance, company policy may prohibit holding more than 5% of any one company. If a user sought to purchase shares that would result in total holdings of more than 5%, receiving an explanation for the denial would allow the user to modify the request and instead purchase 4.9%.

The automatic system of managing pre-clearance requests has the additional advantage of automatically expiring requests submitted too far in the past. This provides the advantage of keeping requests that were not acted upon from continuing to clog the queue.

As discussed above with reference to FIG. 2, supervisory users of the system may wish to investigate certain behaviors by the employees by querying the information stored in the system. This optionally may be accomplished through a web interface.

Some behaviors by employees may be prohibited by company policy or governmental regulations. Instead of running queries manually, the system may check for suspicious or prohibited behavior automatically and alert one or more users when such behavior is encountered. Alerts may use the web portal, email, or other means of notification. Optionally, the system also may notify the employee whose activities triggered the alert. As mentioned with respect to FIG. 2, large accumulations in one company, short term trading of long-term instruments, and violations of most any federal regulation are examples of useful alerts. In some embodiments of the invention, some or all of the alerts and/or reports may be created using third-party software. For example, the Actimize Intelligence Server could help generate alerts and software such as the MicroStrategy Platform, optionally using the MicroStrategy Intelligence Server, may help generate reports.

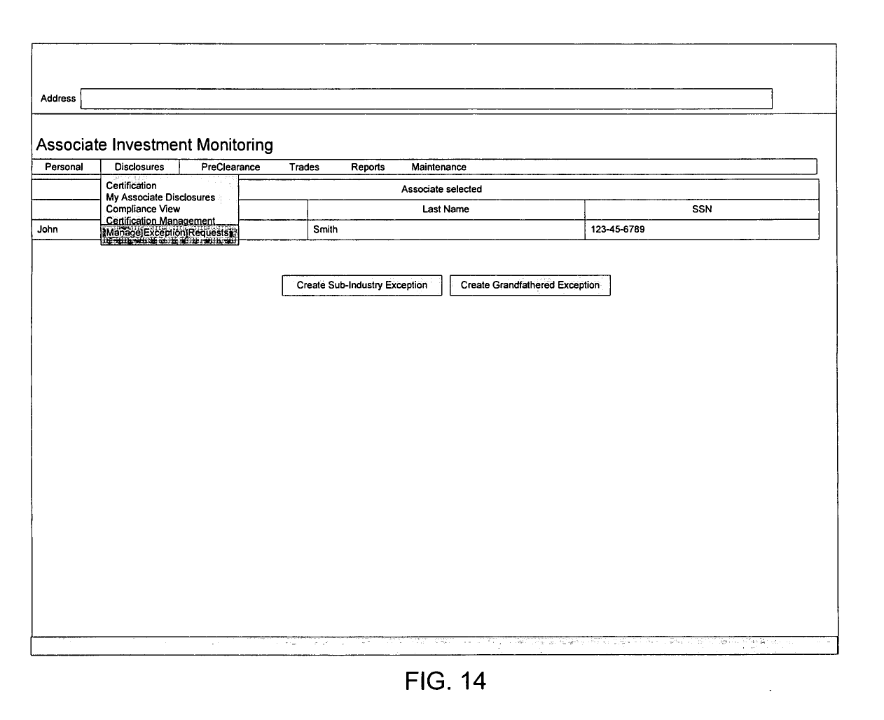

Finally, FIG. 14 illustrates a form for allowing exceptions to the policies normally enforced by the system in accordance with one or more aspects of the present invention. Examples of such policies include the rules that trigger alerts, as mentioned above; the rules governing approval of a pre-clearance request; and the requirement to fill our or assent to certain compliance forms. One skilled in the art will realize that these examples are merely illustrative, and any policy enforced by the system or alerts generated by the system may be disabled by creating exceptions for certain users or groups of users.

The automated system's ability to classify users into groups allows for efficient enforcement of company policy. For example, employees at level A may be subject to different rules than employees at level B. In addition, each business unit may have unique rules. The groups to which each user belongs may determine which rules and policies the system will enforce with respect to that user. A trade that may be acceptable for one user may be denied automatically for another. The potential to handle policies easily that do not apply with uniformity is an advantage in accordance with some aspects of the present invention.

While illustrative embodiments of various aspects of the present invention are shown, those skilled in the art will understand that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative of the present invention, not restrictive thereof.

1. A system comprising:
a web portal configured to receive input data from a user and provide responsive data to the user;
a certification component, operable from the web portal, configured to ensure specific users are certified with at least one investment policy of an entity, the specific users being defined by the at least one investment policy;
a compliance component, operable from the web portal, configured to provide status of compliance of the specific users to the at least one investment policy of the entity, and configured to send emails based upon the status of compliance;
a disclosure management component, operable from the web portal, configured to receive and maintain data representative of investments of users; and
a pre-clearance component, operable from the web portal, configured to receive a pre-clearance request, automatically determine whether to authorize the pre-clearance request, and respond to the pre-clearance request.

2. The system of claim 1, wherein, for each user of the specific users, the certification component is configured to ensure a specific user is certified based upon receipt of an acknowledgement of receipt of the at least one investment policy by the specific user.

3. The system of claim 2, wherein the certification component is further configured to provide access to the at least one investment policy through the web portal.

4. The system of claim 1, wherein, for each user of the specific users, the compliance component is configured to provide a status of compliance of the specific user to a supervisor.

5. The system of claim 4, wherein the compliance component is configured to send emails to specific user determined to not be in compliance to the at least one investment policy.

6. The system of claim 5, wherein the compliance component is further configured to receive input corresponding to a request to send the emails.

7. The system of claim 1, wherein, for each user of the system, disclosure management component is further configured to update the data representative of investments of the user.

8. The system of claim 1, wherein the pre-clearance component is further configured to determine whether the pre-clearance request is to receive an expedited.

9. The system of claim 1, wherein the pre-clearance component is configured to automatically determine whether to authorize the pre-clearance request based upon at least one business rule.

10. One or more computer readable media storing computer executable instructions that, when executed, perform a method comprising:
receiving, at a web portal, input data from a user;
ensuring, by a certification component, specific users are certified with at least one investment policy of an entity, the specific users being defined by the at least one investment policy;
providing, by a compliance component, status of compliance of the specific users to the at least one investment policy of the entity;
sending emails based upon the status of compliance;
receiving and maintaining, at a disclosure management component, data representative of investments of users;
receiving a pre-clearance request;
automatically determining whether to authorize the pre-clearance request; and
responding to the pre-clearance request.

11. The one or more computer readable media of claim 10, wherein, for each specific user, ensuring is based upon receipt of an acknowledgement of receipt of the at least one investment policy by the specific user.

12. The one or more computer readable media of claim 11, the method further comprising providing access to the at least one investment policy through the web portal.

13. The one or more computer readable media of claim 10, wherein sending emails is based upon determining specific users that are not in compliance to the at least one investment policy.

14. The one or more computer readable media of claim 13, the method further comprising receiving input corresponding to a request to send the emails

15. The one or more computer readable media of claim 10, for each user of the system, the method further comprising updating the data representative of investments of the user.

16. The one or more computer readable media of claim 10, the method further comprising determining whether the pre-clearance request is to receive an expedited request.

17. The one or more computer readable media of claim 10, wherein automatically determining is based upon at least one business rule.

18. The one or more computer readable media of claim 10, wherein, for each specific user, ensuring includes:
providing at least one question to the specific user;
receiving input representative of a current response to the at least one question;
associating the response with the specific user;
determining whether a predetermined period of time has elapsed since receiving the response; and
providing the at least one question to the specific user for a new current response.

19. The one or more computer readable media of claim 10, wherein, for each specific user, providing includes outputting a graphical user interface with the status of compliance for the specific user.

20. The one or more computer readable media of claim 10, wherein sending emails includes sending emails to one or more of the specific users and a supervisor.
